(19) United States
(12) Patent Application Publication
(10) Pub. No.: US 2009/0223318 A1
(43) Pub. Date: Sep. 10, 2009

(54) GEAR SHIFT ASSEMBLY

(76) Inventor: Claudio R. Ballard, Huntington, NY (US)

Correspondence Address: HOWISON & ARNOTT, L.L.P, P.O. BOX 741715, DALLAS, TX, 75374-1715, US

(21) Appl. No.: 12/394,379

(22) Filed: Feb. 27, 2009

Related U.S. Application Data
(60) Provisional application No. 61/034,247, filed on Mar. 6, 2008.

(51) Int. Cl. B60K 20/04; F16H 59/04

(52) U.S. Cl. 74/473.34

(57) ABSTRACT

A gear shift assembly includes a base, a cylindrical collar extending from the base, a shift rod having generally spherical tip at a first end thereof for engaging a corresponding socket of a transmission, inner and outer gimbal spheres mounted on the shift rod and supported in the collar whereby the outer truncated gimbal sphere may pivot in the collar in a first direction when the shift rod is moved in the first direction and wherein the inner gimbal sphere is supported in the outer truncated gimbal sphere whereby the inner gimbal sphere may pivot inside the outer truncated gimbal sphere in a second direction substantially perpendicular to the first direction when the shift rod is moved in the second direction.

### CROSS-REFERENCE TO RELATED APPLICATIONS

This application claims the benefit of U.S. Provisional Application for Patent Ser. No. 61/034,247, filed Mar. 6, 2008, and entitled GEAR SHIFT ASSEMBLY, the specification of which is incorporated herein in its entirety by reference.

### TECHNICAL FIELD

The current invention relates to gear shifter mechanisms for transmissions, and in particular to a gear shift assembly for a manual transmission of an automobile.

### BACKGROUND

Manual shift transmissions found in typical automotive application represents one step of the two step mechanical torque multiplication process (the other step is the rear end differential unit) necessary for an internal combustion engine to operate within an RPM range wherein it produces an ideal level of torque and horsepower for optimal performance and mileage at the varying speeds the vehicle is to be operated. The typical internal combustion engine has torque and horsepower bands wherein the torque and horsepower produced will vary proportionally with the RPM. The typical modern gasoline internal combustion engine useable torque range begins at around 1500 RPM and peaks out at about 4500 RPM so that under ideal conditions, a driver wishes to keep engine RPM within that range or band of power until such time as the vehicle has attained a given desired speed. The rear end differential in a vehicle is usually a fixed drive ratio that cannot be altered unless it is mechanically modified. Therefore, in order to keep an engine RPM within a usable power band, the transmission provides the required varying gear ratios. In order for the driver to select the appropriate gear ratio inside the transmission for this purpose, a device known as a transmission shifter provides the driver with the necessary mechanical connection to the internal transmission gear selection mechanism.

FIGS. 10-16 illustrate transmissions and gear shifters in accordance with the PRIOR ART. There exist numerous manufacturers of manual transmissions, and the shifter technology has evolved considerably in the past 25 years. Manual transmissions since automobiles first made their appearance in the late 1800's through the end of 1970's typically employed an external linkage apparatus that provided a mechanical connection between a shift lever that the driver would move in accordance with a given shift pattern for the transmission being operated and typically up to 3 levers or arms that protruded from various locations on the longitudinal side of the transmission as shown in FIG. 10 and FIG. 11. These levers or arms in turn were connected to forks inside the transmission that when actuated externally via the shifter linkage would move a collar element containing teeth that would engage with a given gear being selected thus engaging that gear in the transmission. Being external to the transmission case and therefore exposed to the elements, the shifter linkage would often suffer considerable wear and require periodic adjustments or repair in order to make sure the gears were being properly selected and fully engaged when the driver move the shifter lever.

By the early 1980's a new shifter linkage design began to emerge that replaced the external shift linkage design wherein the shift linkage functionality was built into the transmission case itself in the form of device called a rail gear selector as shown in FIG. 12 and FIG. 13.

This new design vastly decreased the complexity of the shifter itself by internalizing shifter linkages which also removed them from exposure to the elements. The new shifter design (see FIG. 14) included a single lever assembly having a shift handle at one end (for the driver to grasp and move in order to select gears) and a simple small spherical tip at the other end which would be inserted into an opening on the top of the transmission gear box and rest in a actuator lever having a matching spherically hollowed out cavity.

FIG. 10 depicts the older late 1950's through early 1980's transmission shifter and linkage design and FIG. 11 shows the same shifter installed on a typical four speed transmission of the time.

FIG. 12 shows a simplistic diagram of the internal workings of the newer style transmission depicted in FIG. 13 wherein the entire external gear shift linkage as shown in FIGS. 10 and 11 has been completely eliminated and an entirely new design has been implemented where the linkage and gear shift mechanism is now internalized inside the transmission. The resulting changes streamline the exterior of the shifter by eliminating external shifter linkage with a simpler design that requires a ball at the end of a rod to rest in the gear selector socket shown in FIG. 12.

The resulting gear shifter itself as shown in FIG. 14 is simplified compared to prior designs. FIG. 15 shows a transmission without the shifter installed to illustrate the socket where the ball at the end of the shifter rod is inserted to enable shifting of transmission gears. A variant of the new style transmission shown in FIG. 13 appears in FIG. 16 offering three separate positions where shifter can be installed (denoted as Positions 1, 2 and 3 in FIG. 16). This position selection allows for variations of driver positions in the vehicle that can vary depending on the wheelbase and interior design of a given vehicle.

Current shifter designs consist of a simple central ball and socket mechanism. Protruding from the bottom of the central ball is a short rod ending with a spherically shaped tip at its base that is inserted into the socket mechanism of the transmission. Extending upwards in the opposite direction from the central ball of the ball and socket mechanism is a simple rectangular shaft that typically has threaded bolt holes so that a shifter handle can be bolted to it on one end and the other end of the shifter handle is threaded so that a shifter handle can be screwed on to its end.

Current shifter designs tend to be utilitarian and are designed to be made as inexpensively as possible. As a result, these designs are usually cosmetically unappealing and are typically concealed with some sort of leather or rubber boot so that only the actual shifter handle is visible inside the automobile interior. This cosmetically unappealing design is used regardless of the vehicle, even for vehicles costing hundreds of thousands of dollars.

### SUMMARY

According to the present disclosure, in one aspect thereof, a gear shift assembly is provided. The gear shift assembly includes a base having a central aperture for receiving a shift rod. The gear shift assembly also includes a generally cylindrical collar that extends upwardly from the base. A shift rod with a generally spherical tip at a first end for engaging a corresponding socket of a transmission is provided. The shift rod includes a handle at a second end. The shift rod passes through an inner gimbal sphere such that the inner gimbal sphere is positioned between the first and second ends of the shift rod. An outer gimbal sphere is provided that includes an upper outer truncated gimbal hemisphere and a lower truncated gimbal hemisphere. The outer gimbal sphere defines a generally spherical inner cavity for receiving the inner gimbal sphere.

The outer truncated gimbal sphere is supported in the collar such that the outer truncated gimbal sphere may pivot in the collar in a first direction when the shift rod is moved in the first direction. Further, the inner gimbal sphere is supported in the outer truncated gimbal sphere such that the inner gimbal sphere may pivot inside the outer truncated gimbal sphere in a second direction substantially perpendicular to the first direction when the shift rod is moved in the second direction. The assembly further includes a substantially rigid trim cap. The trim cap has upper and lower openings and a central passage extending therebetween. The shift rod passes though the trim cap with at least a portion of the inner gimbal sphere exposed though through the upper opening. In one embodiment, a portion of the outer gimbal sphere may be exposed through the upper opening. The trim cap engages the collar to secure the trim cap to base.

The present disclosure, in another aspect thereof, provides a gear shift assembly that includes a base that has a central aperture for receiving a shift rod therethrough. The base includes a plurality of openings for fastening the base to a transmission. A generally cylindrical collar that extends upwardly from the base has an upper wall, a threaded exterior surface, a plurality of spaced apart screw holes extending through the collar and the base, and two opposed semicylindrical openings formed in the top wall of the collar. An upper outer truncated gimbal hemisphere has a bottom wall with four semicylindrical recesses formed at ninety degree intervals in the bottom wall and a plurality of spaced apart screw holes extending into the bottom wall. A lower outer truncated gimbal hemisphere has a top wall with four semicylindrical recesses formed at ninety degree intervals in the top wall and a plurality of screw holes extending through the lower outer truncated gimbal hemisphere. A plurality of screws extend through the screw holes to secure the upper and lower gimbal spheres halves together such that the upper and lower outer gimbal hemispheres form an outer truncated gimbal sphere. The outer truncated gimbal sphere defines a generally spherical inner cavity that opens on opposed sides of the outer, truncated gimbal sphere with the semicylindrical recesses in opposed relationship to form four cylindrical pin receiving openings at ninety degree intervals around a circumference of the outer truncated gimbal sphere.

A shift rod having spherical tip at a first end thereof for engaging a corresponding socket of a transmission, a handle at a second end thereof and a pivot pin receiving opening formed between the first and second ends is provided. The inner gimbal sphere is positioned between the first and second ends of the shift rod with opposed openings aligned with the pin receiving opening of the shift rod. The inner gimbal sphere is received in the generally spherical inner cavity of the outer, truncated gimbal sphere with the shift rod passing through the collar and central aperture of the base. A first pivot pin extends through the inner gimbal sphere and shift rod. The pivot pin is positioned in opposed ones of the cylindrical pin receiving openings of the truncated outer gimbal sphere. Thus, the inner gimbal sphere may pivot inside the outer gimbal sphere in a first direction when the shift rod is moved in the first direction.

Second pivot pins are positioned in opposed ones of the cylindrical pin receiving openings and extend from the outer truncated gimbal sphere to engage the opposed semicylindrical openings formed in the top wall of the collar. Thus, the outer truncated gimbal sphere may pivot in the collar in a second direction substantially perpendicular to the first direction when the shift rod is moved in the second direction.

A plurality of springs are interposed between the base and the outer truncated gimbal sphere. The springs bias the outer truncated gimbal sphere and shifter shaft to a center position. A retaining ring is configured to fit over the upper outer truncated gimbal hemisphere. A plurality of screws extends through the base, the collar and engage the retaining ring to secure the outer, truncated gimbal sphere within the collar.

A substantially rigid trim cap, having a small diameter upper opening and a large diameter lower opening with a central passage extending between the upper opening and lower opening, is provided. The shifter shaft passes though the trim cap with at least a portion of the inner gimbal sphere exposed though through the small diameter upper opening. The trim cap has internal threads formed around the circumference passage at the lower end for engaging the outer threaded surface of the collar to secure the trim cap to the collar, thereby securing a trim plate to the base.

The present disclosure, in still another aspect thereof, provides a gear shift assembly comprising a frame, an outer gimbal member and an inner gimbal member. The frame has an upper exterior surface defining a substantially circular first aperture having a first inner diameter. The outer gimbal member is rotatably mounted to the frame to allow rotation relative to the frame about a first axis. An upper portion of the outer gimbal member has a ring-shaped exterior configuration defining a substantially circular outer surface having a second outer diameter and a substantially circular second aperture having a second inner diameter. The second outer diameter is substantially equal to the first inner diameter minus a clearance distance. The outer gimbal member is disposed within the frame such that the upper portion of the outer gimbal member is positioned within the first aperture. The inner gimbal member is rotatably mounted to the outer gimbal member to allow rotation relative to the outer gimbal member about a second axis. The second axis is oriented substantially perpendicular to the first axis. An upper portion of the inner gimbal member has an exterior configuration defining a substantially circular outer surface having a third outer diameter. The third outer diameter is substantially equal to the second inner diameter minus a clearance distance. The inner gimbal member is disposed within the outer gimbal member such that the upper portion of the inner gimbal member is positioned within the second aperture.

### BRIEF DESCRIPTION OF THE DRAWINGS

For a more complete understanding, reference is now made to the following description taken in conjunction with the accompanying Drawings in which:

FIG. 1 is a perspective view of a gear shift assembly according to the present disclosure;

FIG. 2 is a top view of the base of the shifter assembly of FIG. 1;

FIG. 3 is a first exploded view of the shifter assembly of FIG. 1 with some parts omitted for clarity;

FIG. 4 is a side view of the inner and outer gimbal spheres of the shift assembly of FIG. 1;

FIG. 5 is a second exploded view of the shift assembly of FIG. 1 with some parts omitted for clarity;

FIG. 6 is a first sectional view of the shift assembly of FIG. 1;

FIG. 7 is a second sectional view of the shift assembly of FIG. 1 taken at 90° from the sectional view of FIG. 6;

FIG. 8 is a second perspective view of a shift assembly according to the present disclosure;

FIG. 9 is a perspective view of the shift assembly of FIG. 1 installed in an open cockpit, two seat roadster style automobile;

FIG. 10 shows a vintage shifter and linkage design according to the PRIOR ART;

FIG. 11 shows the PRIOR ART shifter and linkage design of FIG. 10 installed on a vintage transmission;

FIG. 12 shows a schematic diagram of a newer transmission according to the PRIOR ART;

FIG. 13 shows an external view of the PRIOR ART transmission of FIG. 12;

FIG. 14 shows another gear shifter design according to the PRIOR ART;

FIG. 15 shows another PRIOR ART transmission without the shifter installed; and

FIG. 16 shows a variant of the PRIOR ART transmission of FIG. 13 with multiple gear shifter mounting locations.

### DETAILED DESCRIPTION

Referring now to the drawings, wherein like reference numbers are used herein to designate like elements throughout, the various views and embodiments of a gear shift assembly are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

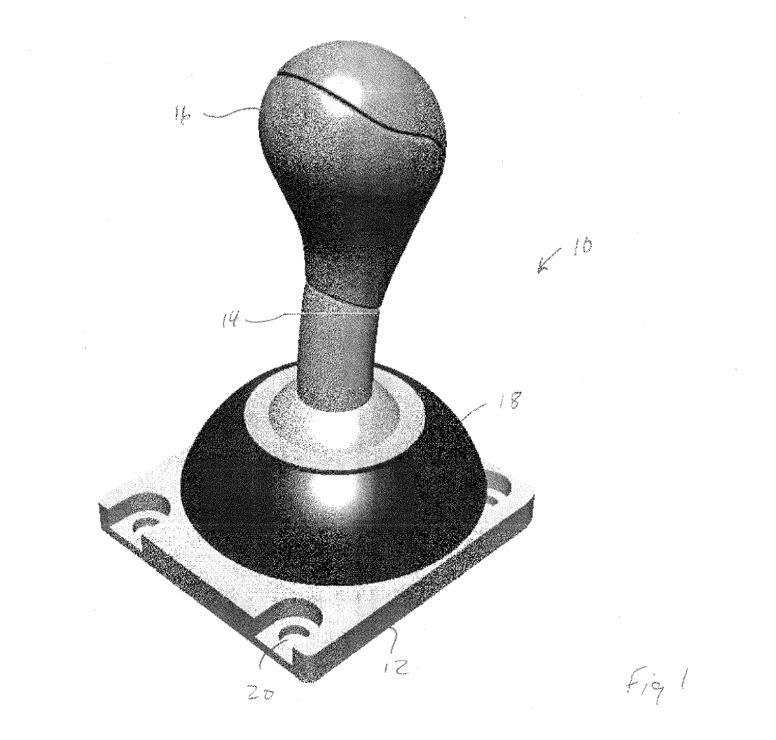

FIG. 1 is a perspective view of a gear shift assembly 10 according to this disclosure. Gear shift assembly 10 is adapted for use with manual transmissions, in particular manual transmissions having four to six speeds. Assembly 10 includes a base 12, a trim cap 18, a shift rod 14, and a handle 16 mounted on the shift rod. As illustrated, base 12 includes a plurality of openings such as bolt holes 20 arranged around the perimeter of the base at locations corresponding to the bolt pattern of a transmission on which the gear shift assembly is mounted. In the illustrated embodiment, base 12 has a rectangular configuration, however, other geometries such as circular, triangular or oblong may be used so long as the openings 20 are correctly positioned in the base to enable shift assembly 10 to match the belt pattern on the applicable transmission.

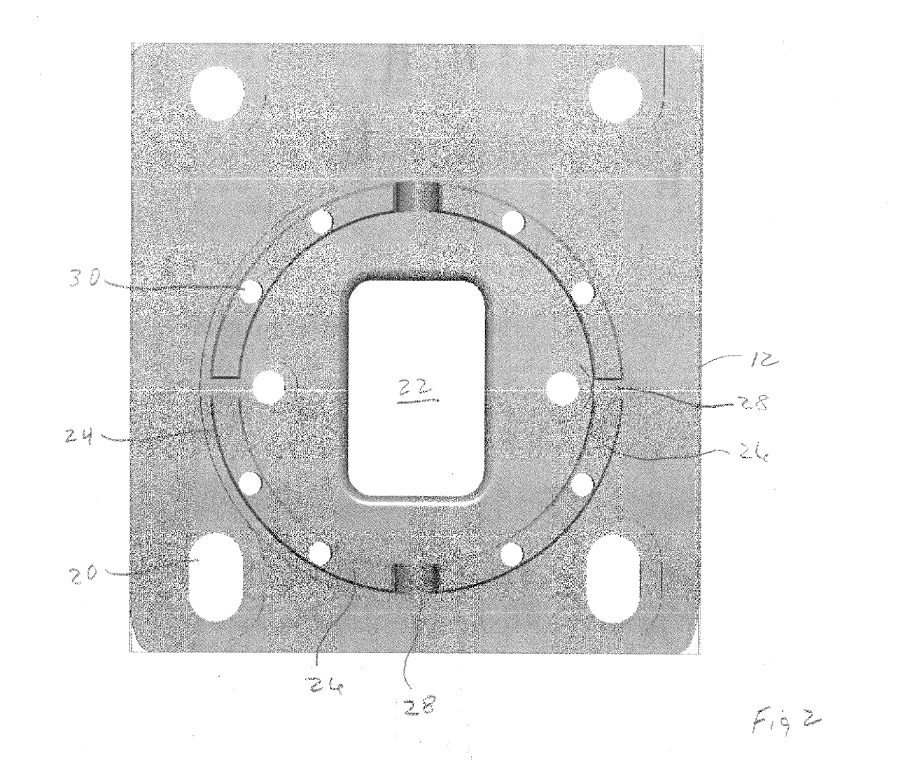

FIG. 2 is a top view of base 12 of shift assembly 10. Base 12 includes a central aperture 22 through which the shift rod of assembly 10 extends to the transmission. Base 12 includes a cylindrical collar 24 extending upwardly from the base. Collar 24 may be integrally formed with base 12 or otherwise fastened to the base. A plurality of openings or screw holes 30 extend through base 12 and collar 24 in a spaced apart relationship around the circumference of the collar. Collar 24 includes a top wall 26 having a pair of semi-cylindrical openings 28 formed in the top wall.

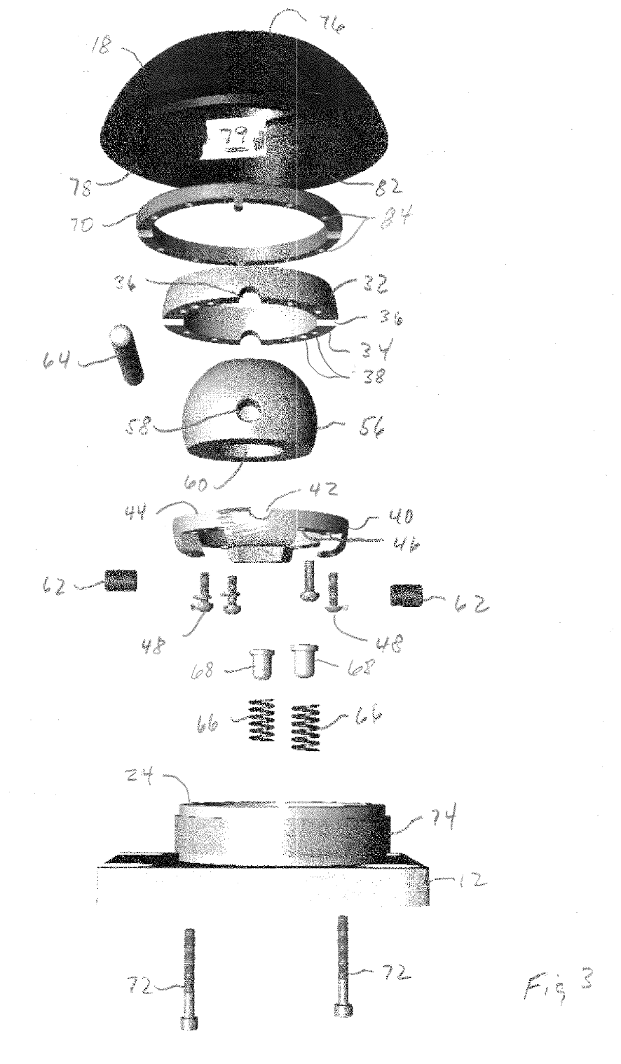

FIG. 3 is an exploded view of gear shift assembly 10 with the shift rod omitted for clarity. Assembly 10 includes an inner gimbal sphere 56 having a central opening 60 through which shift rod 14 passes. Inter gimbal sphere 56 also includes a pin receiving hole 58 extending through both sides of the inner gimbal sphere that receives a pivot pin 64 for securing shift rod 14 in the inner gimbal sphere. Inner gimbal sphere 56 is received in a lower outer gimbal hemisphere 40, which has the shape of a truncated hemisphere. Lower outer gimbal hemisphere 40 has a top wall 44 and a plurality of screw holes 46 formed through the hemisphere and upper wall 44. Four semi-cylindrical recesses 42 are formed in the lower outer gimbal hemisphere 40. An upper outer gimbal hemisphere 32, also having the shape of a truncated hemisphere, fits over inner gimbal sphere 56 and includes a bottom wall 34 having a plurality of screw holes 38 formed therein. Upper gimbal hemisphere 32 also includes four semi-cylindrical recesses 36 formed in a bottom wall 34 thereof.

FIG. 4 is a side view of inner gimbal sphere 56 positioned in upper and lower gimbal hemispheres 32 and 40. Upper and lower gimbal hemispheres 32 and 40 together form an outer gimbal sphere 50 having truncated upper and lower sides. Outer gimbal sphere 50 defines a generally spherical inner cavity 52 having a geometry corresponding to the outer surface of inner gimbal sphere 56. Outer gimbal sphere 50 and inner gimbal sphere 56 are formed to have a relatively tight clearance therebetween on the order of several thousandths of an inch or less. As illustrated, the semi-cylindrical recesses 36 and 42, formed in the upper and lower gimbal hemispheres 32 and 40 form four cylindrical pin receiving openings 54.

Referring again to FIG. 3, upper gimbal hemisphere 32 is secured to lower gimbal hemisphere 40 with a plurality of screws 48 that extend through screw holes 46 and 38 in the upper and lower gimbal hemispheres. In the illustrated embodiment, a plurality of cut-outs 45 are formed in the lower gimbal hemisphere in the area of screw holes 46. In other embodiments, cut-outs 45 may be omitted. A retaining ring 70 configured to fit over upper gimbal hemisphere 32 includes a plurality of threaded openings 84 formed around the circumference of the retaining ring. A plurality of cap head screws 72 extend up through base 12, screw holes 30 and collar 24 and engage threaded openings 84 of retaining ring 70 to secure the inner and outer gimbal spheres 56 and 50 in the collar.

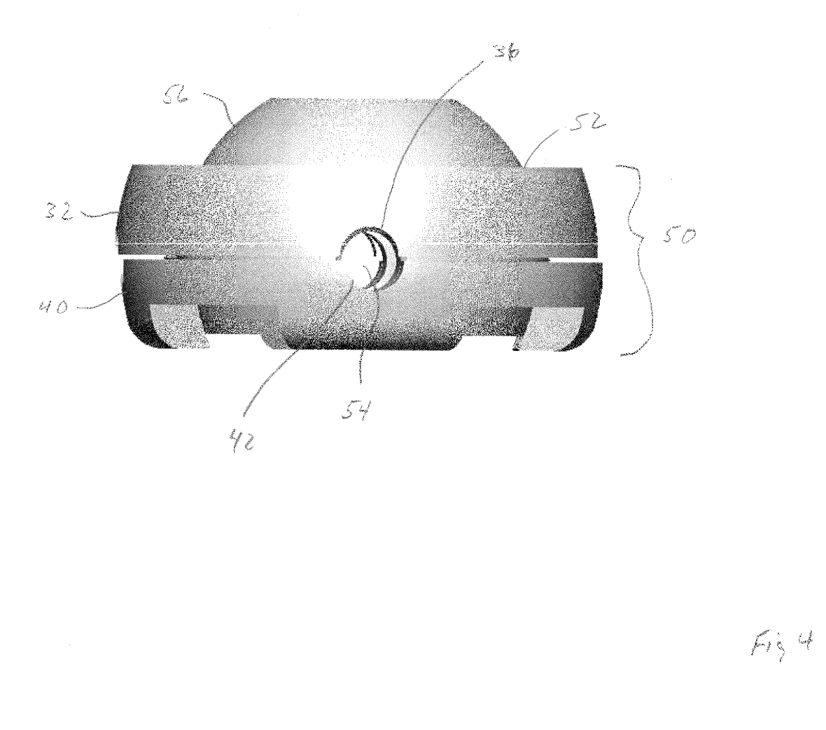

FIG. 5 is a partial exploded view of gear shift assembly 10 with parts omitted for clarity. As illustrated, inner gimbal sphere 56 is positioned approximately midway along the length of shift rod 14 and is secured onto the shift rod with pivot pin 64 that extends through pin receiving holes 58 and a corresponding hole in the shift rod. The ends of pivot pin 64 are received in two of the four pin receiving openings 54 (FIG. 4) in outer gimbal sphere 50. This configuration allows shift rod 14 and inner gimbal sphere 56 to pivot in the fore and aft direction within the outer gimbal sphere 50.

A pair of short pivot pins 62 are retained in the remaining two cylindrical pin receiving openings 54 in outer gimbal sphere 50. The ends of short pivot pin 62 are received in semi-cylindrical recesses 28 formed in collar 24. This configuration allows the shift rod, inner gimbal sphere and outer gimbal sphere to pivot from side to side within collar 24. A pair of followers 68 are received in springs 66 interposed between base 12 and the lower outer gimbal hemisphere 40. Springs 66 bias the outer hemisphere 50 and shift rod 14 to a center position. Followers 68 prevent springs 66 from wearing against the bottom of outer hemisphere 40.

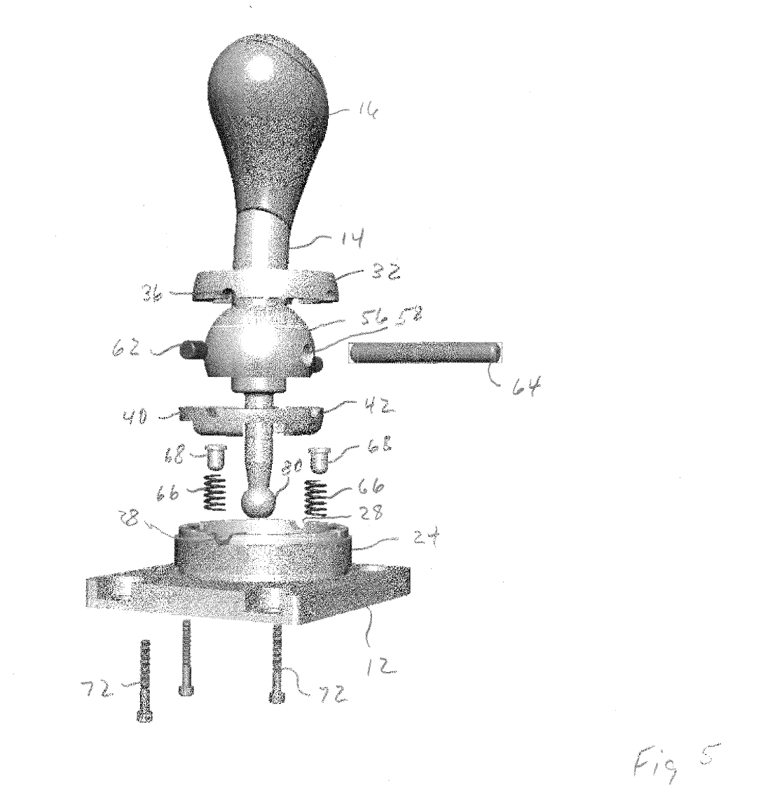

FIG. 6 is a partial sectional view taken through short pivot pins 62 of shift assembly 10. In one embodiment, short pivot pins 62 are secured in position in lower outer gimbal hemisphere 40 with set screws 86. As illustrated, shift rod 14 includes a spherical tip formed at the end of the shift rod opposite handle 14. Spherical tip 80 is configured to engage a corresponding feature in the transmission that assembly 10 is mounted on.

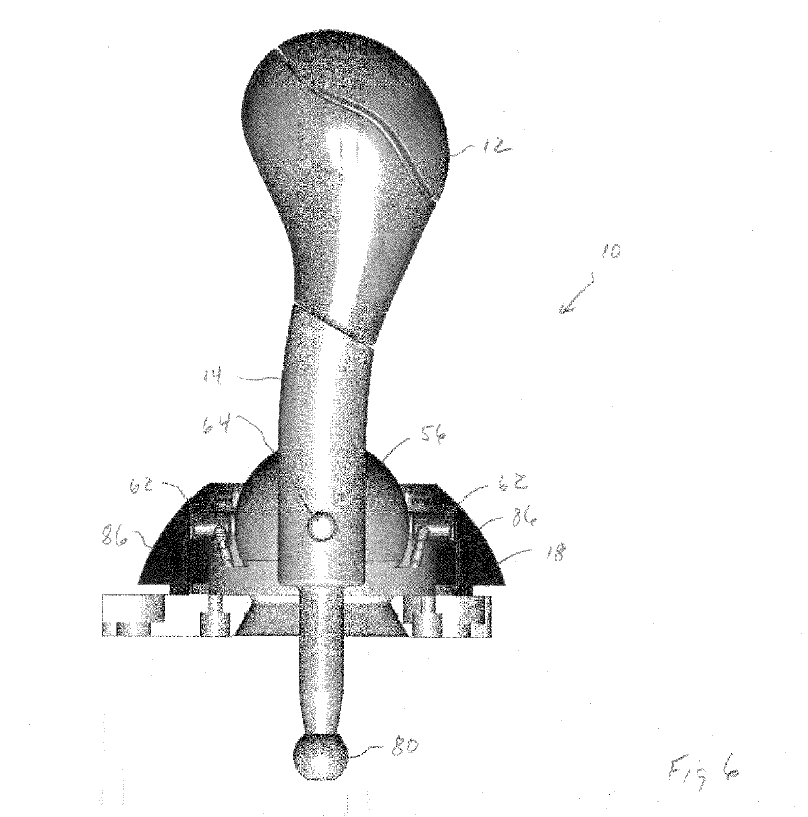

FIG. 7 is a second sectional view of shift assembly 10 taken through pivot pin 64 of FIG. 5. As illustrated, pivot pin 64 passes through a pivot hole 88 formed in shift rod 14. The ends of pivot pin 64 are received in pivot receiving holes 54 (FIG. 4) formed in outer gimbal sphere 50 to enable the shift rod to pivot around the pin in a fore and aft direction.

Referring again to FIG. 3, trim cap 18 has a generally hemispherical configuration with a central opening or passage 79 extending between a small diameter upper opening 76 and a large diameter lower opening 78. Trim cap 18 also includes internal threads 82 formed around the circumference of central passage 80 adjacent to large diameter lower opening 78. Threads 82 are configured to engage a threaded surface 74 of collar 24 to secure the trim cap to base 12.

FIG. 8 is a perspective view of a shift assembly 10 according to the disclosure incorporating a trim plate 90. In the embodiment shown in FIG. 8, a trim plate 90 is configured to fit over base 12. Trim plate 90 is secured onto base 12 by trim cap 18 which is secured to collar 24.

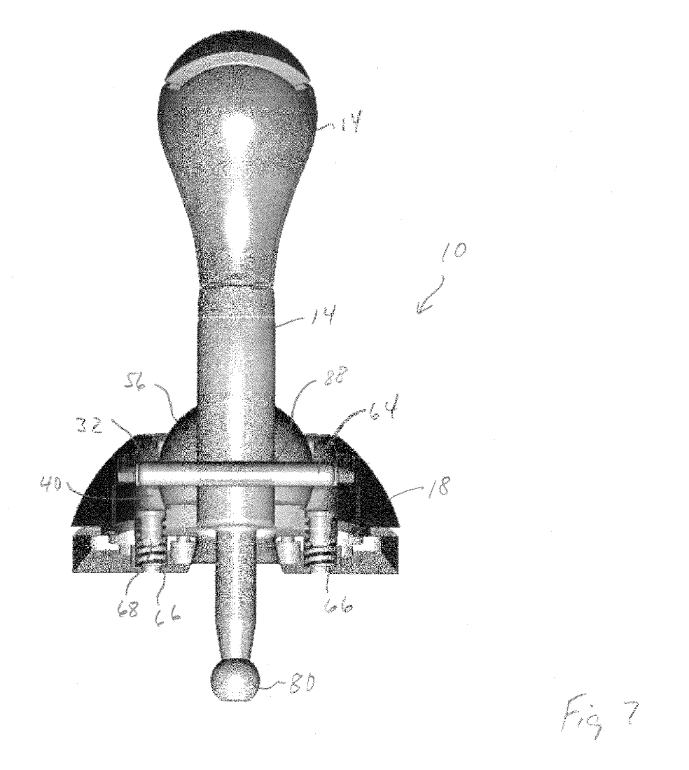

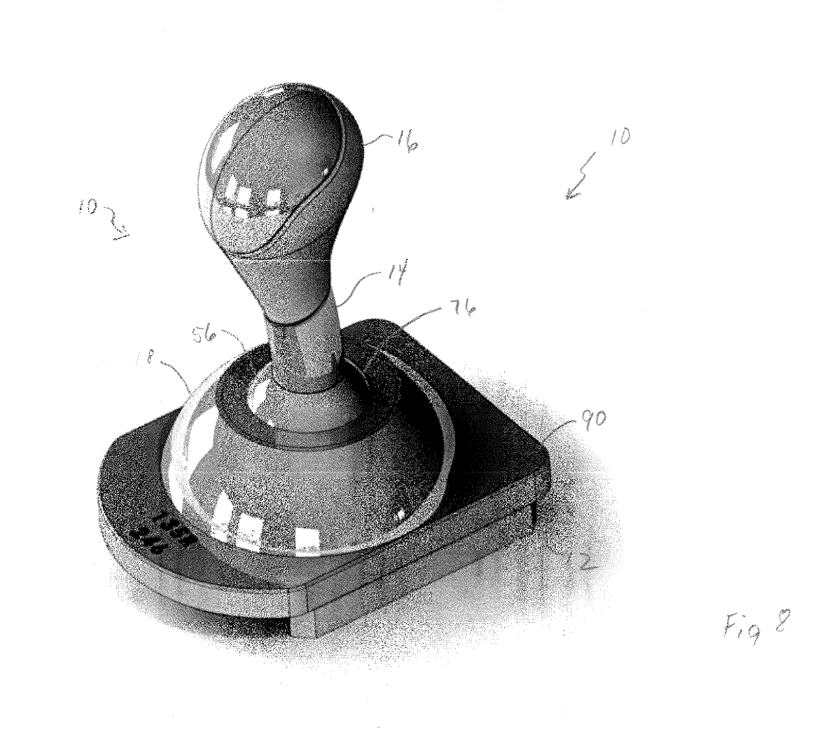

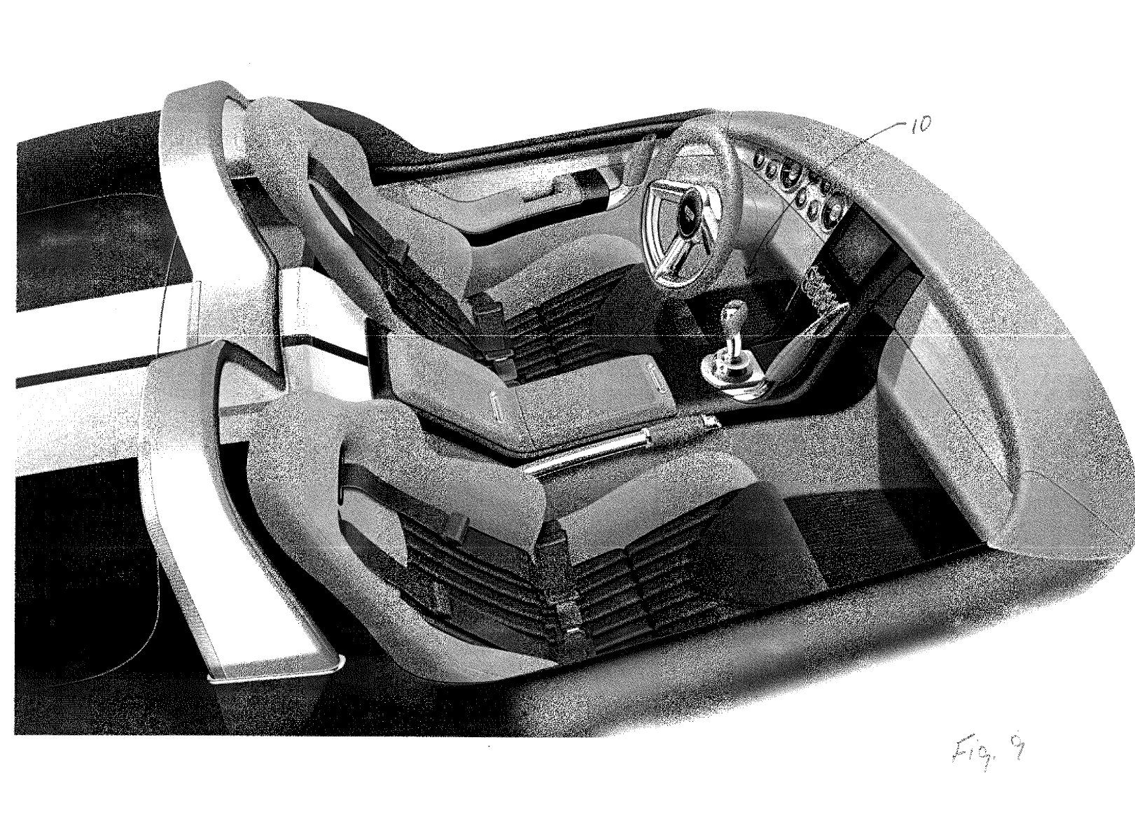

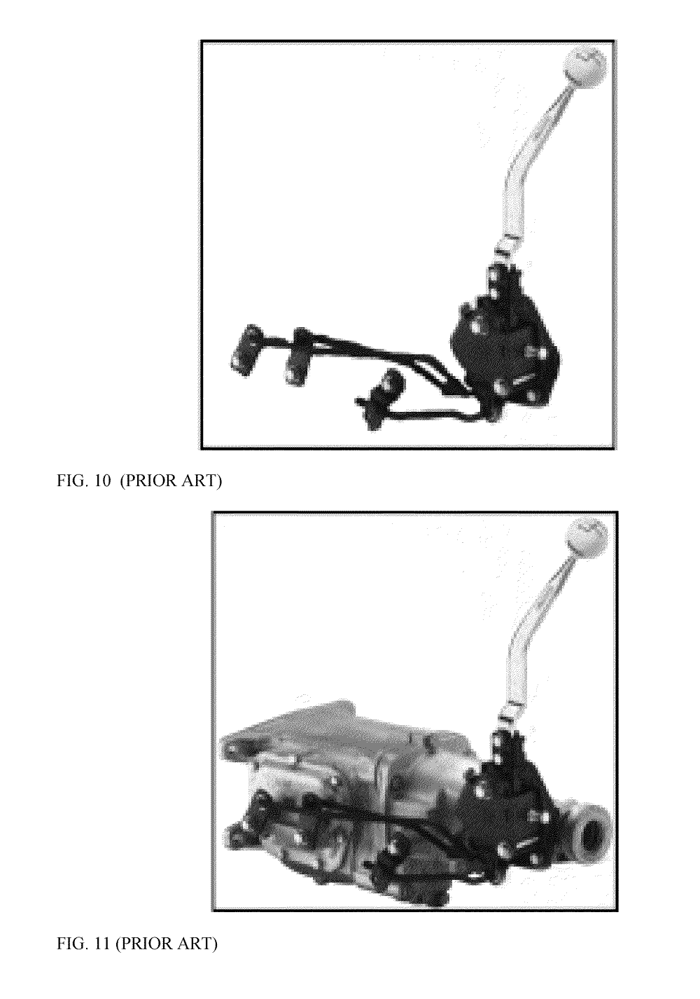

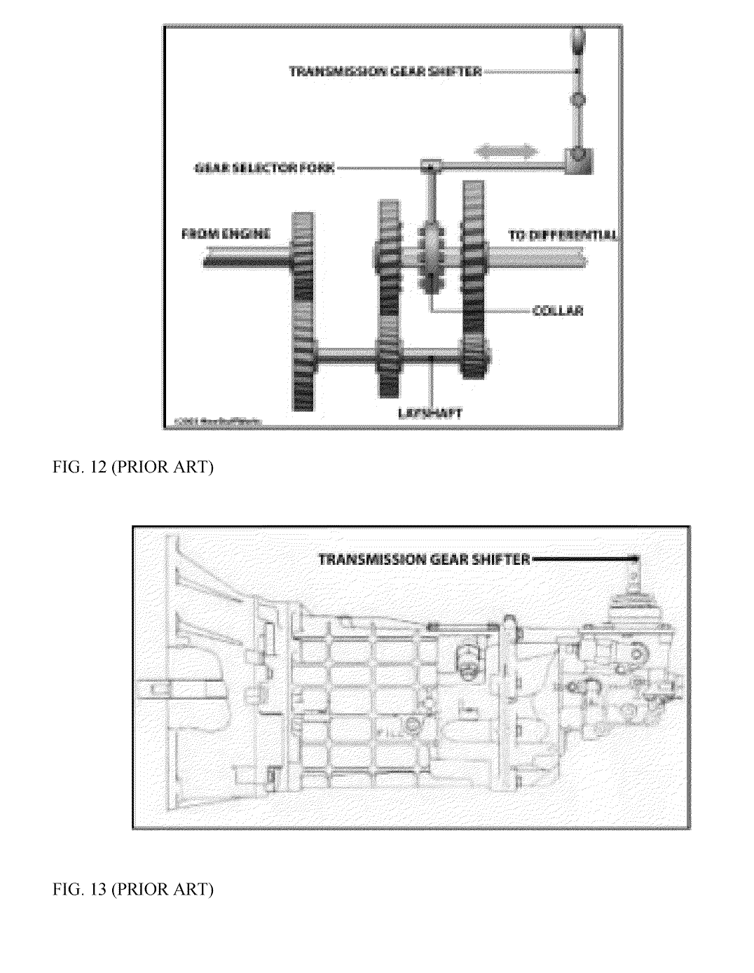

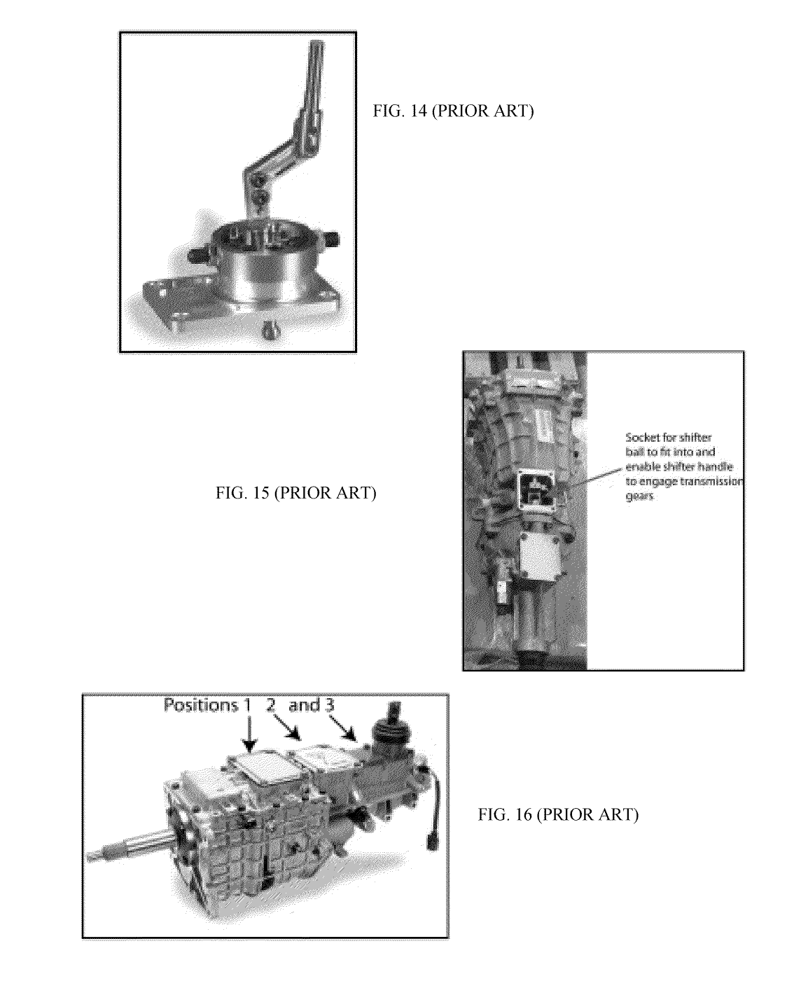

FIG. 9 is a perspective view of shift assembly according to the disclosure installed in an open cockpit two seat roadster style automobile. In contrast to the unsightly rubber or leather boots used to cover prior art shift assemblies trim cap 18 and trim plate 84 are formed from substantially rigid materials such as metals or suitable plastics. The exposed surfaces of trim plate 84, trim cap 18 and the exposed portion of inner sphere 56 may be polished or otherwise treated to present in an aesthetically pleasing appearance.

It will be appreciated by those skilled in the art having the benefit of this disclosure that this gear shift assembly provides a gear shift assembly for a manual transmission of a vehicle. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1 A gear shift assembly comprising:
a base having a central aperture for receiving a shift rod therethrough;
a generally cylindrical collar extending upwardly from the base;
a shift rod having generally spherical tip at a first end thereof for engaging a corresponding socket of a transmission, and a handle at a second end thereof;
an inner gimbal sphere, the shift rod passing through the inner gimbal sphere such that the inner gimbal sphere is positioned between the first and second ends of the shift rod;
an outer gimbal sphere including:
an upper outer truncated gimbal hemisphere and a lower truncated gimbal hemisphere, the outer gimbal sphere defining a generally spherical inner cavity for receiving the inner gimbal sphere therein, the generally spherical inner cavity opening on opposed sides of the outer gimbal sphere;
wherein the outer truncated gimbal sphere is supported in the collar whereby the outer truncated gimbal sphere may pivot in the collar in a first direction when the shift rod is moved in the first direction and wherein the inner gimbal sphere is supported in the outer truncated gimbal sphere whereby the inner gimbal sphere may pivot inside the outer truncated gimbal sphere in a second direction substantially perpendicular to the first direction when the shift rod is moved in the second direction; and
a substantially rigid trim cap, the trim cap having upper and lower openings and a central passage extending therebetween whereby the shift rod passes though the trim cap with at least a portion of the inner gimbal sphere exposed though through the upper opening, the trim cap engaging the collar to secure the trim cap to base.

2. The gear shift assembly of claim 1 wherein the outer gimbal sphere includes first opposed pin receiving openings, the gear shift assembly further comprising a first pivot pin passing through the inner gimbal sphere and shift rod, wherein the ends of the pivot pin are engage in the first opposed pin receiving openings.

3. The gear shift assembly of claim 1 wherein the collar further comprises a top wall with opposed semicylindrical recesses and the outer gimbal sphere includes second opposed pin receiving openings, the gear shift assembly further comprising second pivot pins received in the second opposed pin receiving openings, the second pivot pins extending substantially perpendicular to the first pivot pin and beyond the outer gimbal sphere wherein the second pins engage the semicylindrical recesses.

4. The gear shift assembly of claim 1 further comprising a trim plate disposed between the trim cap and the base.

5 . The gear shift assembly of claim 1 wherein the trim cap is threadedly engaged with the collar.

6. The gear shift assembly of claim 1 wherein the trim cap is one of press fit or glued onto the collar.

7. A gear shift assembly comprising:
a base having a central aperture for receiving a shift rod therethrough and a plurality of openings in the base for fastening the base to a transmission;
a generally cylindrical collar extending upwardly from the base, the collar having an upper wall, a threaded exterior surface, a plurality of spaced apart screw holes extending through the collar and the base and two opposed semicylindrical openings formed in the top wall of the collar;
an upper outer truncated gimbal hemisphere having a bottom wall with four semicylindrical recesses formed at ninety degree intervals in the bottom wall and a plurality of spaced apart screw holes extending into the bottom wall;
a lower outer truncated gimbal hemisphere having an top wall with four semicylindrical recesses formed at ninety degree intervals in the top wall and a plurality of screw holes extending through the lower outer truncated gimbal hemisphere;
a plurality of screws extending through the screw holes to secure the upper and lower gimbal hemispheres together wherein the upper and lower outer gimbal hemispheres form an outer truncated gimbal sphere, wherein the outer truncated gimbal sphere defines a generally spherical inner cavity that opens on opposed sides of the outer, truncated gimbal sphere with the semicylindrical recesses in opposed relationship to form four cylindrical pin receiving openings at ninety degree intervals around a circumference of the outer truncated gimbal sphere;
a shift rod having spherical tip at a first end thereof for engaging a corresponding socket of a transmission, a handle at a second end thereof and a pivot pin receiving opening formed between the first and second ends;
an inner gimbal sphere having opposed opening therein, the inner gimbal sphere positioned between the first and second ends of the shift rod with the opposed openings aligned with the pin receiving opening of the shift rod and wherein the inner gimbal sphere is received in the generally spherical inner cavity of the outer, truncated gimbal sphere with the shift rod passing through the collar and central aperture of the base;
a first pivot pin extending through the inner gimbal sphere and shift rod, the pivot pin positioned in opposed ones of the cylindrical pin receiving openings of the truncated outer gimbal sphere, whereby the inner gimbal sphere may pivot inside the outer gimbal sphere in a first direction when the shift rod is moved in the first direction;
second pivot pins positioned in opposed ones of the cylindrical pin receiving openings and extending from the outer truncated gimbal sphere to engage the opposed semicylindrical openings formed in the top wall of the collar whereby the outer truncated gimbal sphere may pivot in the collar in a second direction substantially perpendicular to the first direction when the shift rod is moved in the second direction;
a plurality of springs interposed between the base and the out outer truncated gimbal sphere, the springs biasing the outer truncated gimbal sphere and shifter shaft to a center position;
a retaining ring configured to fit over the upper outer truncated gimbal hemisphere;
a plurality of screws extending through the base, the collar and engaging the retaining ring to secure the outer, truncated gimbal sphere within the collar;
a trim plated configured to cover the base, the trim plate having an opening therethrough for receiving the collar; and
a substantially rigid trim cap, the trim cap having a small diameter upper opening and a large diameter lower opening with a central passage extending between the upper opening and lower opening whereby the shifter shaft passes though the trim cap with at least a portion of the inner gimbal sphere exposed though through the small diameter upper opening, the trim cap having internal threads formed around the circumference passage at the lower end for engaging the outer threaded surface of the collar to secure the trim cap to the collar whereby the trim cap secures the trim plate to the base.

8. A gear shift assembly comprising:
a frame having an upper exterior surface defining a substantially circular first aperture having a first inner diameter;
an outer gimbal member rotatably mounted to the frame to allow rotation relative to the frame about a first axis;
an upper portion of the outer gimbal member having a ring-shaped exterior configuration defining a substantially circular outer surface having a second outer diameter and a substantially circular second aperture having a second inner diameter;
the second outer diameter being substantially equal to the first inner diameter minus a clearance distance;
the outer gimbal member being disposed within the frame such that the upper portion of the outer gimbal member is positioned within the first aperture; and
an inner gimbal member rotatably mounted to the outer gimbal member to allow rotation relative to the outer gimbal member about a second axis;
the second axis being oriented substantially perpendicular to the first axis;
an upper portion of the inner gimbal member having an exterior configuration defining a substantially circular outer surface having a third outer diameter;
the third outer diameter substantially equal to the second inner diameter minus a clearance distance;
the inner gimbal member being disposed within the outer gimbal member such that the upper portion of the inner gimbal member is positioned within the second aperture.

9. A gear shift assembly in accordance with claim 8, further comprising a shift rod extending from the inner gimbal member along a third axis substantially perpendicular to the first axis and the second axis.

10. A gear shift assembly in accordance with claim 9, wherein the upper end of the shift rod is adapted to receive a handle and the lower end of the shift rod is adapted to engage a corresponding feature in a transmission.

11. A gear shift assembly in accordance with claim 8, wherein the frame further comprises:
a base portion having the outer gimbal portion mounted thereto; and
a trim cap portion mounted over the base, an upper surface of the trim cap defining the upper exterior surface of the frame

12. A gear shift assembly in accordance with claim 8, wherein the clearance distance is about 0.003 inches or less.

13. A gear shift assembly in accordance with claim 8, wherein the outer gimbal member has a substantially flat upper face.

14. A gear shift assembly in accordance with claim 13, wherein the flat upper face of the outer gimbal member may be positioned in substantially alignment with the first aperture of the frame.

15. A gear shift assembly in accordance with claim 14, wherein the inner gimbal member has a substantially hemispherical upper surface.

16. A gear shift assembly in accordance with claim 15, wherein the hemispherical upper surface of the inner gimbal member is positioned to extend above the flat upper face of the outer gimbal member.

17. A gear shift assembly in accordance with claim 8, wherein the inner gimbal member has a substantially hemispherical upper surface.

18. A gear shift assembly in accordance with claim 8, wherein the inner gimbal member is mounted to the outer gimbal member by a pivot pin extending through the inner gimbal member along the second axis and having opposing ends attached to the outer gimbal member.

19. A gear shift assembly in accordance with claim 18, wherein the outer gimbal member is mounted to the frame by a pair of pivot pins extending from the outer surface of the outer gimbal member along the first axis and having opposing ends attached to the frame.

20. A gear shift assembly in accordance with claim 19, further comprising a plurality of springs mounted between the outer gimbal member and the frame to bias the outer gimbal member toward a predetermined position with respect to the frame.
